(19) United States
(12) Patent Application Publication
(10) Pub. No.: US 2008/0160219 A1
(43) Pub. Date: Jul. 3, 2008

(54) Cellulose Ester Film. Polarizing Plate and Liquid-Crystal Display Device

(75) Inventors: Osamu Takahashi, Kanagawa (JP); Kunihiro Atsumi, Kanagawa (JP)

Correspondence Address: BUCHANAN, INGERSOLL & ROONEY PC, POST OFFICE BOX 1404, ALEXANDRIA, VA, 22313-1404, US

(73) Assignee: FUJIFILM Corporation, Tokyo (JP)

(21) Appl. No.: 11/885,045

(22) PCT Filed: Feb. 24, 2006
(86) PCT No.: PCT/JP06/04037

§ 371 Date: Aug. 24, 2007

(30) Foreign Application Priority Data
Feb. 25, 2005 (JP) 2005-051233

(51) Int. Cl. C09K 19/00; B32B 23/04

(52) U.S. Cl. 428/1.1; 428/532

(57) ABSTRACT

A cellulose ester film comprising a cellulose ester and a reaction product between at least one epoxy compound and at least one polymerization accelerator; a polarizing plate using the cellulose ester film as a protective layer of a polarizer; and a liquid crystal display device using either the cellulose ester film or the polarizing plate.

### TECHNICAL FIELD

The present invention relates to a cellulose ester film, a polarizing plate and a liquid-crystal display device.

### BACKGROUND ART

Since cellulose ester films are transparent, have excellent physical and mechanical properties, and exhibit a small dimensional change against temperature and humidity changes, they have hitherto been used in a variety of fields such as bases for photographic films, tracing films for drawing, and electric insulating materials. Recently, they have been used as polarizing plates for use in liquid-crystal display (LCD), protective films or optically-compensatory film supports for circular polarizing plate for use in organic EL display, and retardation films. On the other hand, since LCD is thin, light, and small in electric power consumption, it has been widely used instead of CRT. Accordingly, demands for these retardation films and polarizing plates are increasing as LCD comes into wide use. Its use has also been expanded from conventional small articles such as electronic calculators and watches to large articles such as automobile meters, PC monitors, and televisions.

Since the display devices such as LCD are always put in use for a long period of time in many cases, the retardation films and polarizing plates are apt to be physically damaged and quality of displaying images are deteriorated when they are damaged, so that it is desired to increase mechanical strength thereof. Furthermore, it has been desired to have such a long-term durability that image quality of LCD is hardly deteriorated even when LCD is used for a long period of time under an environment where temperature and humidity may change.

In the polarizing plate, a protective layer is generally attached to both faces or one face of a polarizer having polarizability via an adhesive layer. As a material for the polarizer, polyvinyl alcohol (hereinafter referred to as PVA) is mainly used. After a PVA film is subjected to monoaxial stretching, it is dyed with iodine or a dichroic dye or stretched after dyeing, and further it is crosslinked with a boron compound, whereby a polarizer is formed. As the protective layer, mainly a cellulose ester, especially cellulose triacetate (TAC) is employed since it is necessary for the layer to be optically transparent and small in birefringence and have a smooth surface. Also for the other optical films, cellulose acetate is employed.

However, in the case that cellulose triacetate is, for example, used as a protective layer, there are a problem that moisture penetrated through the protective layer influences components constituting the polarizer, such as iodine, to decrease polarizability of the polarizer under a long-term high-temperature and high humidity environment and a problem that deformation may occur at high temperature and high humidity. Accordingly, a technology for lowering water vapor permeability of cellulose triacetate films and the other cellulose esters films and a technology for mechanically strengthening them have been desired.

Against the problems, there is a description in JP-A-2004-109307 that the above problems are remedied by converting the cellulose into three-dimensionally crosslinked cellulose utilizing remaining hydroxyl groups in the cellulose ester films through incorporation of a crosslinking agent. However, cellulose ester films are usually reproduced by dissolving used films thereof and sub-standard films generated during production steps in a good solvent and then reused from the viewpoints of efficient use of resources and cost reduction. When cellulose is three-dimensionally crosslinked as above, there arises a problem that it is impossible to reuse the cellulose because of its insoluble nature. Therefore, a method which allows reuse of cellulose and also is effective is desired. Incidentally, in JP-A-2004-109307, the polymerization accelerator to be used in the invention is not described. Moreover, it is reported that a sheet comprising a norbornene-based resin is useful as a protective film (protective layer) of polarizers (JP-A-10-101907). However, the sheet comprising a norbornene-based resin has a sufficiently small water vapor permeability but its adhesiveness with a polarizer is insufficient, so that the sheet is not yet satisfactory as a protective layer.

Furthermore, JP-A-2004-285159 discloses a transparent film comprising a semi-IPN (semi-interpenetrating network structure) type polymer alloy of a cellulose ester and a crosslinked polymer. However, the technology disclosed in JP-A-2004-285159 includes a crosslinked polymer obtained by photo-polymerization of a low-molecular-weight compound having a polymerizable unsaturated double bond but the low-molecular-weight compound is highly toxic and volatile and hence there is a fear that pollution may occur during its production steps. In addition, the photo-polymerization requires a large-scale production equipment and hence a current production facility should be widely changed in some cases. Furthermore, in photo-polymerization, since a thick film is irradiated with light, polymerization is extremely difficult to carry out even when an apparatus for shutting out oxygen is fitted and a problem of residual monomer and the like is well predicted. Incidentally, in JP-A-2004-285159, the polymerization accelerator to be used in the invention is not described.

### DISCLOSURE OF THE INVENTION

An object of the invention is to provide a cellulose ester film which is (1) less apt to cause deterioration of planarity, (2) less apt to absorb moisture, (3) low in water vapor permeability and excellent in storability, (4) capable of reuse since formation of three-dimensionally crosslinked cellulose ester can be minimized, and (5) excellent in productivity.

Another object of the invention is to provide a polarizing plate and a liquid-crystal display device constituted using the cellulose ester film.

The above objects of the invention are achieved by the following constitution.

(1) A cellulose ester film comprising:

a cellulose ester; and

a reaction product between at least one epoxy compound and at least one polymerization accelerator.

(2) The cellulose ester film as described in (1) above,

wherein the cellulose ester is substantially not three-dimensionally crosslinked.

(3) A cellulose ester film obtained by a method comprising:

casting a solution comprising a cellulose ester, at least one epoxy compound and at least one polymerization accelerator; and then.

subjecting the casted solution to heat treatment at 70° C. or higher,

wherein the cellulose ester is substantially not three-dimensionally crosslinked.

(4) The cellulose ester film as described in any of (1) to (3) above,

wherein the at least one epoxy compound is at least one compound selected from compounds represented by formulae (I), (II), (III) and (IV):

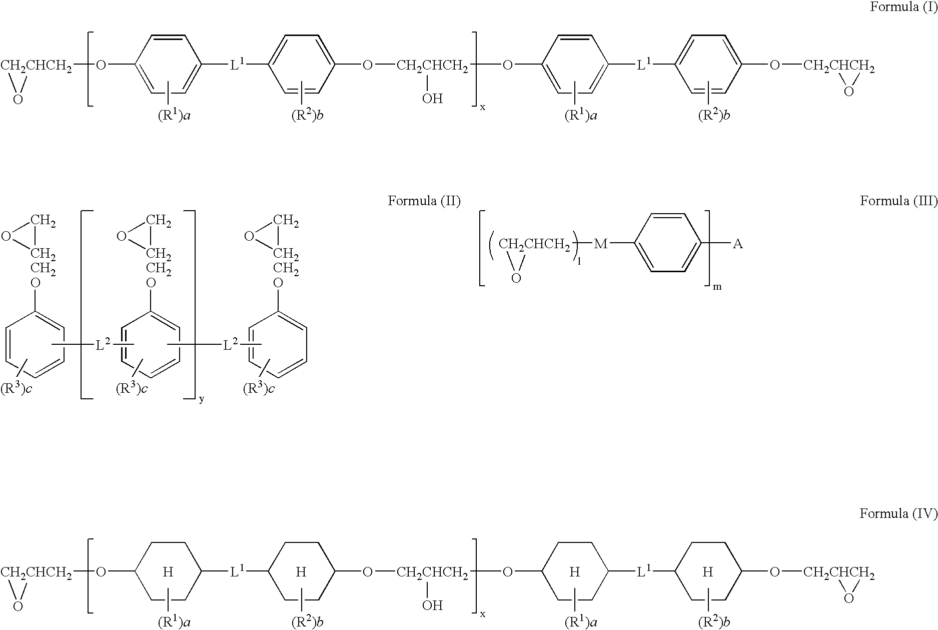

wherein R¹, R² and R³ each independently represents an alkyl group or a halogen atom;

L¹ and L² each independently represents a divalent aliphatic organic group;

M represents an oxygen atom or a nitrogen atom;

A represents a m-valent connecting group;

a, b and c each independently represents an integer of from 0 to 4;

x and y each independently represents a real number of from 0 to 20;

l represents 1 or 2; and

m represents an integer of from 2 to 4.

(5) The cellulose ester film as described in any of (1) to (4) above,

wherein the at least one polymerization accelerator is at least one compound selected from the group consisting of amine-derivatives, acid anhydrides and imidazole derivatives.

(6) The cellulose ester film as described in any of (1) to (5) above,

wherein the cellulose ester has a degree of acyl substitution of from 2.9 to 3.0.

(7) The cellulose ester film as described in any of (1) to (6) above,

wherein the cellulose ester is a triacetyl cellulose, a cellulose acetate propionate or a cellulose acetate butyrate.

(8) A polarizing plate comprising:

a polarizer; and

at least one protective layer of the polarizer,

wherein the at least one protective layer comprises a cellulose ester film as described in any of (1) to (7) above.

(9) A liquid-crystal display device comprising a cellulose ester film as described in any of (1) to (7) above.

(10) A liquid-crystal display device comprising a polarizing plate as described in (8) above.

### BEST MODE FOR CARRYING OUT THE INVENTION

The following will describe the invention further in detail.

First, the epoxy compound represented by the following formula (I), (II), (III), or (IV) is described in more detail.

In the formulae (I), (II), and (IV), there may be, for example, mentioned as L¹ or L²:

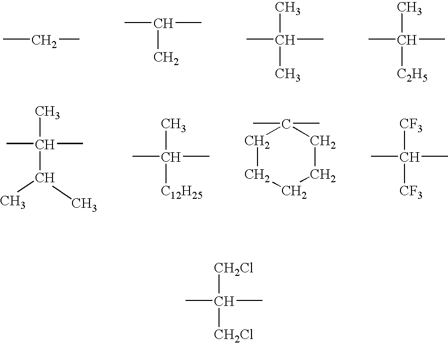

In the formula (III), the followings may be mentioned as A:

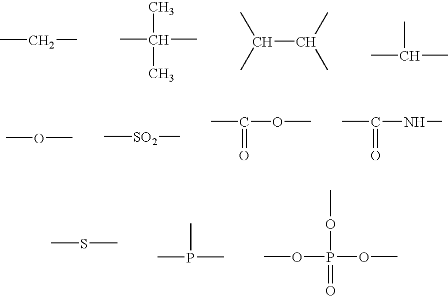

As the alkyl group for R¹, R² or R³, an alkyl group having 1 to 3 carbon atoms is preferred and the halogen atom includes Br, Cl, F, or the like.

The following shows specific examples of the epoxy compound represented by the formula (I), (II), (III) or (IV) but the invention is not limited thereto.

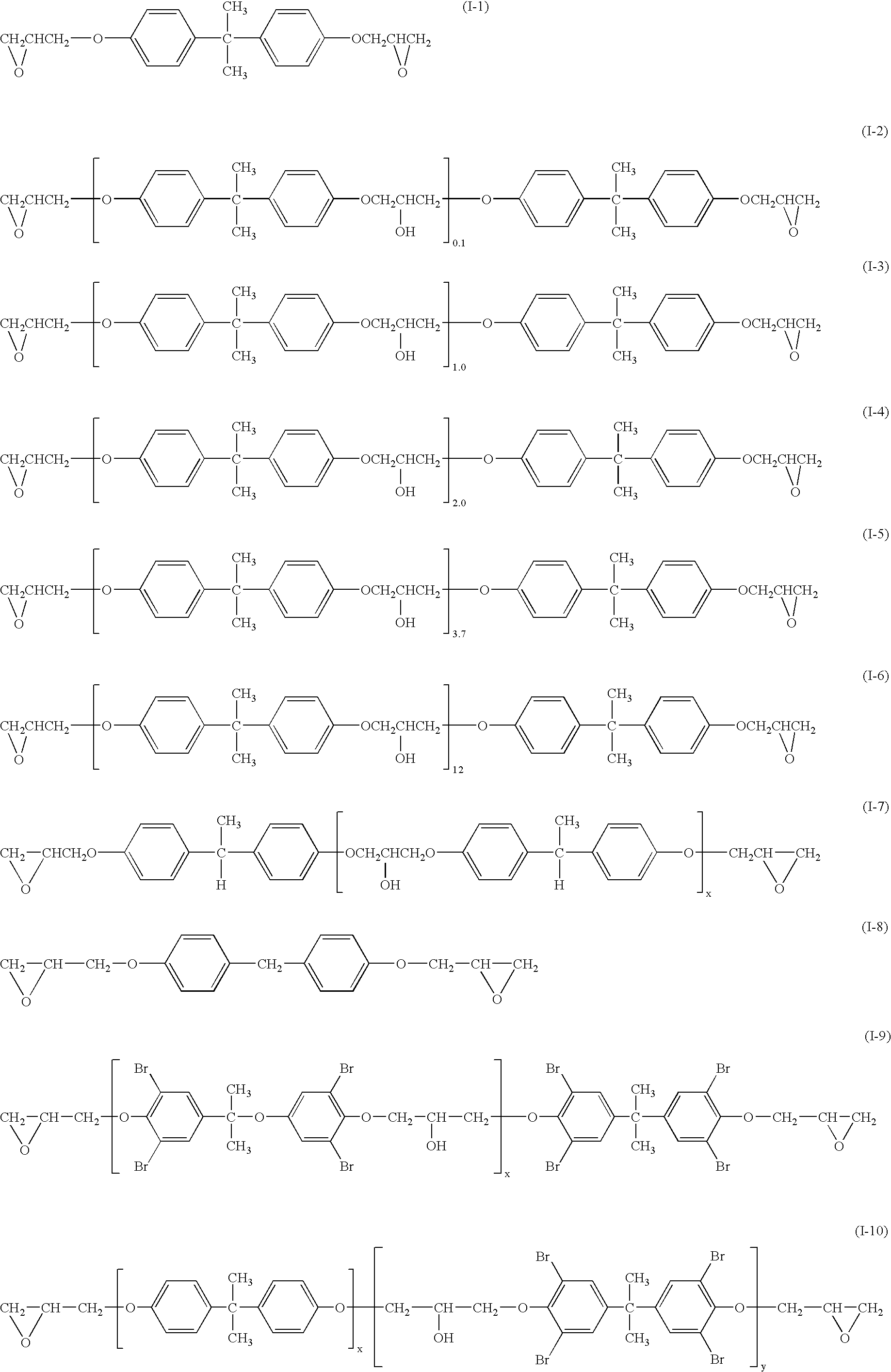

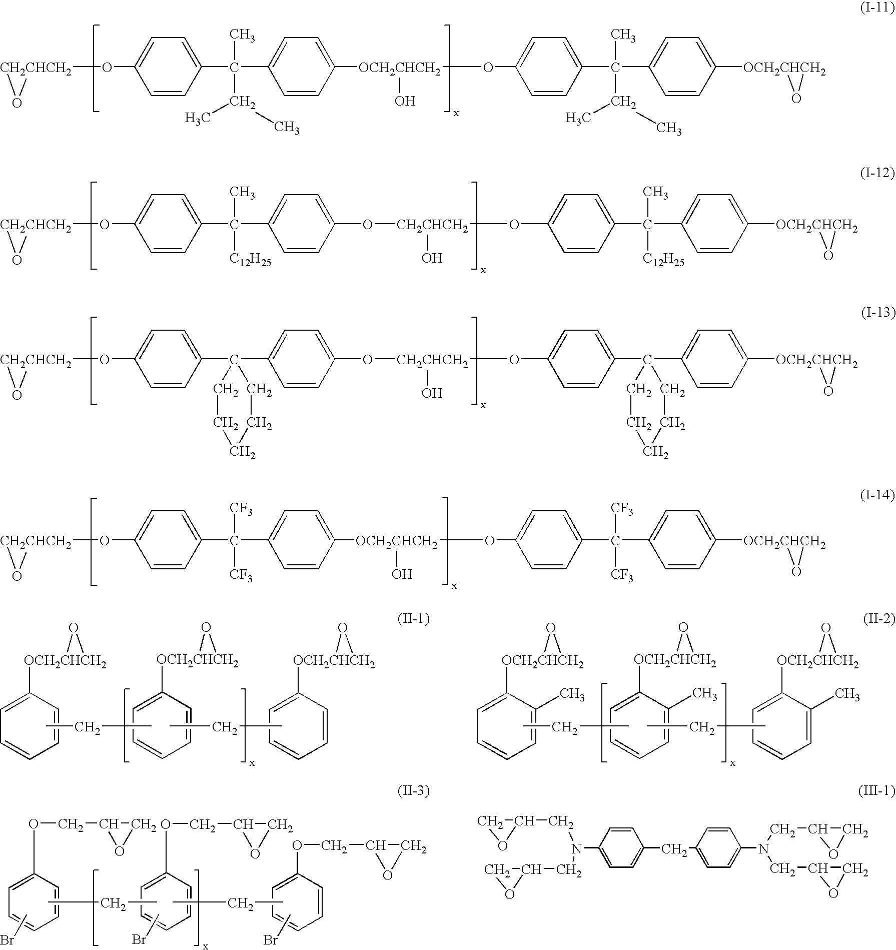

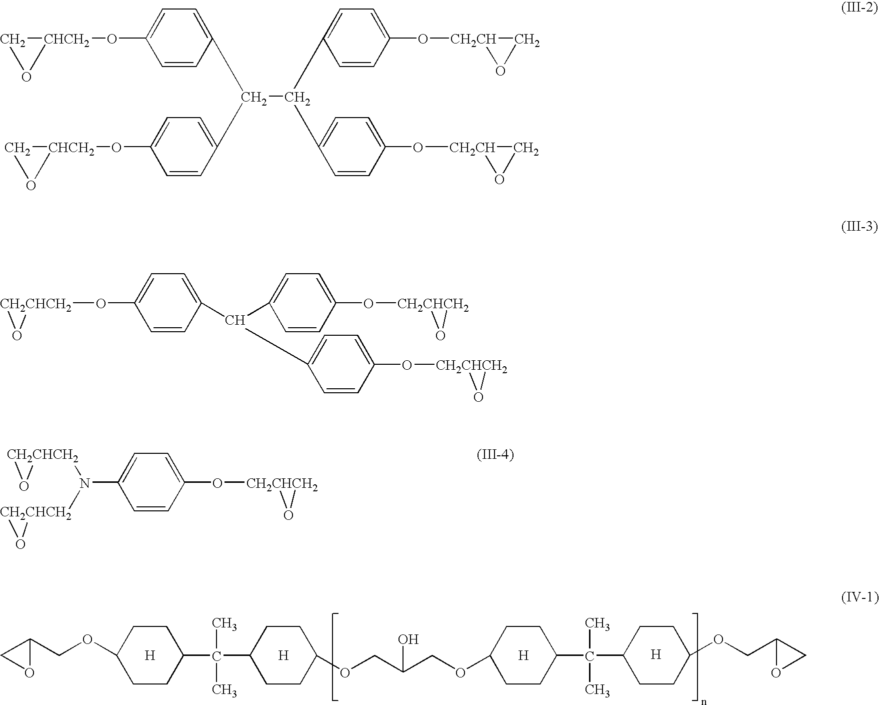

In this connection, the variable numbers x, y and n each is a real number and may be any number as far as each of them is in the range of from 0 to 20. The reason why x, y and n are not always integers is that epoxy compounds having several kinds of integer values are mixed in a certain ratio and the numbers represent average values thereof. These epoxy compounds may be used solely or in combination with two or more thereof.

As specific examples of epoxy compounds other than the structures represented by the formulae (I) to (IV), the following compounds may be mentioned:

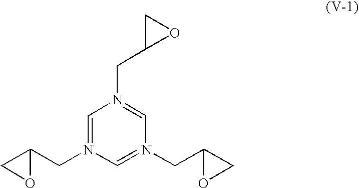

The following will describe the polymerization accelerator to be used in the invention.

The polymerization accelerator is a compound which accelerates the polymerization (or crosslinking) reaction of the epoxy compounds and does not substantially three-dimensionally crosslink the cellulose ester. The polymerization accelerator induces the condensation reaction of the accelerator itself with the epoxy compound and acts as a catalyst to accelerate the reaction of the epoxy compounds themselves, whereby a network structure is formed in the cellulose ester. As the polymerization accelerator, there may be mentioned substituted or unsubstituted amines, imidazoles, mercaptans, acid anhydrides, polyamide resins, organic acid hydrazides, and the like. In particular, at least one compound selected from the group consisting of amine derivatives, acid anhydrides, and imidazole derivatives is preferred.

As preferred specific examples, there may be mentioned the following compounds:

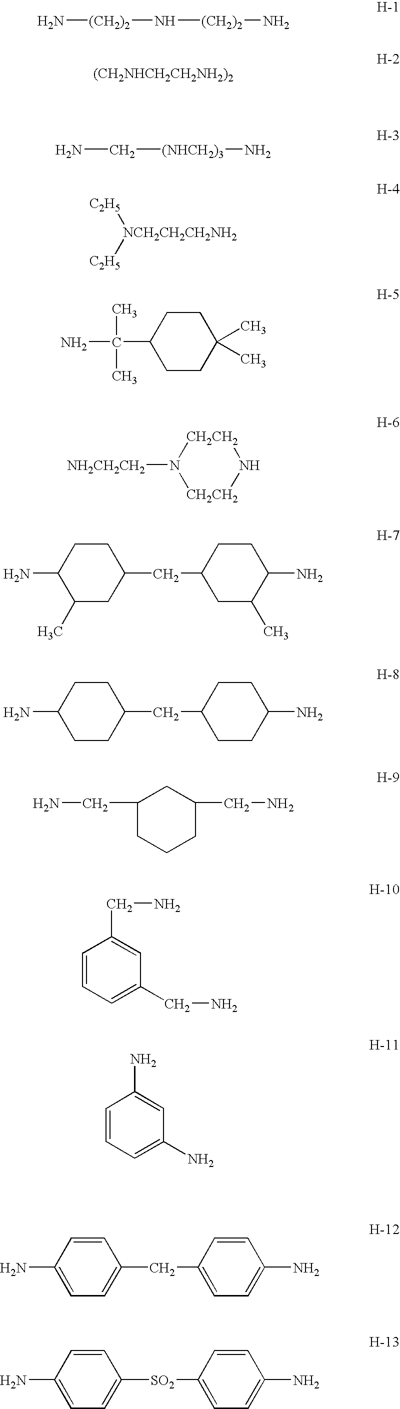

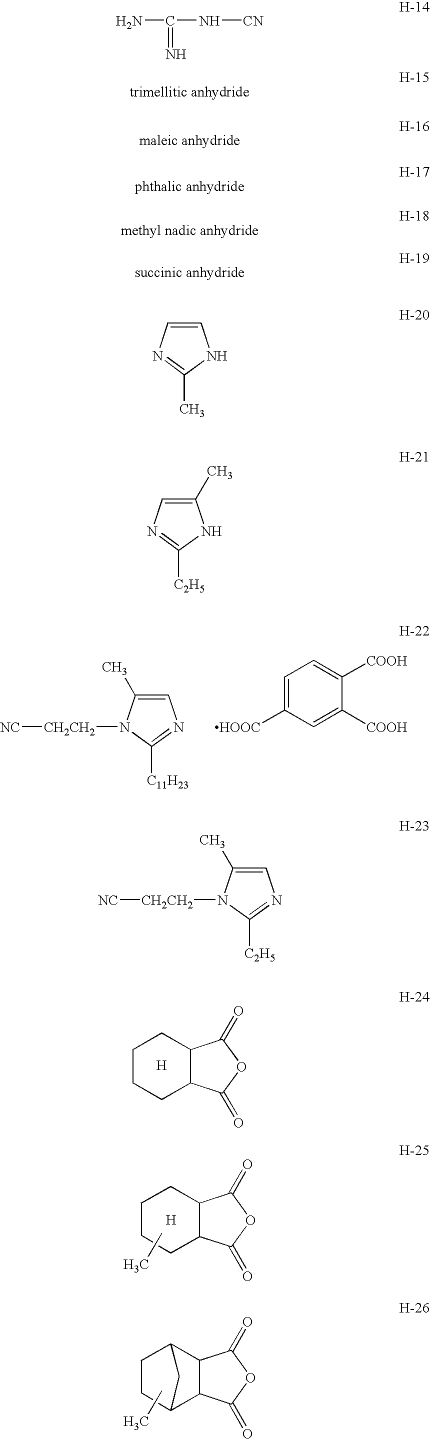

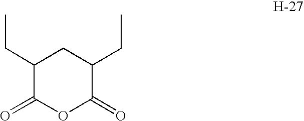

In addition, there are a polysulfide resin (Three Bond 2104 manufactured by Three Bond), ethylene glycol bistrimellitate, glycerol tristrimellitate, and the like but the polymerization accelerator is not limited thereto. Moreover, it is also preferred to use them in combination.

In the invention, bifunctional amine derivatives are most preferred since they form network structures without crosslinking the cellulose ester.

In this connection, the presence of the three-dimensional crosslinking in the cellulose ester can be judged by immersing the cellulose ester in a solvent capable of dissolving the cellulose ester, e.g., methylene chloride, and determining whether the cellulose ester is dissolved therein. Moreover, “cellulose ester is substantially not three-dimensionally crosslinked” herein means that the ratio of crosslinking of the hydroxyl group (an unreacted hydroxyl group is not present in the case that degree of substitution is 3.0) in the cellulose ester is 5% or less. The ratio is preferably 3% or less, most preferably 1% or less. The ratio of crosslinking of the hydroxyl group present in the cellulose ester can be calculated by a method of detecting OH group on NMR.

In the invention, the amount of the epoxy compound to be used is preferably from 1% to 30% based on the mass of the cellulose ester. The amount is more preferably from 2% to 20%, further preferably from 3% to 15%. (In this specification, mass ratio is equal to weight ratio.)

Moreover, the mount of the polymerization accelerator to be used is preferably from 1% to 100%, more preferably from 5% to 50%, even more preferably from 10% to 40% based on the mass of the epoxy compound to be used.

Next, the cellulose ester to be used in the invention is explained.

As the cellulose ester to be used in the invention, there may be mentioned cellulose esters such as triacetyl cellulose (TAC), diacetyl cellulose (DAC), cellulose acetate propionate (CAP), cellulose acetate butyrate (CAB), cellulose acetate phthalate, cellulose acetate trimellitate and cellulose nitrate. In particular, triacetyl cellulose, cellulose acetate propionate or cellulose acetate butyrate is preferred.

The above cellulose esters are preferably used for the cellulose ester film of the invention. More preferably, with regard to the degree of substitution of the cellulose ester, when the degree of substitution with an acyl group is represented by X, X is preferably from 2.5 to 3.0, more preferably from 2.7 to 3.0, most preferably from 2.9 to 3.0. When the degree of substitution is high, there is no risk of crosslinking the cellulose and it is possible to prepare a dope having a high concentration (hereinafter, a solution wherein a cellulose ester, an epoxy compound, a polymerization accelerator, and the like are dissolved in a solvent is referred to as dope), so that the case is advantageous for film formation and drying and preferred for achieving the objects of the invention.

A glucose unit constituting cellulose has three bindable hydroxyl groups. For example, in cellulose triacetate, in the case that all of three hydroxyl groups of the glucose unit are bound to acetyl groups, the degree of substitution with the acetyl groups is 3.0.

The degree of acyl substitution can be measured in accordance with ASTM-D817-96.

The starting cellulose of the cellulose ester for use in the invention is not particularly limited and there may be mentioned cotton linter, wood pulp, kanaf, and the like. Moreover, the cellulose derivatives obtained therefrom can be used solely or as a mixture thereof in any ratio but it is preferably to use cotton linter in an amount of 50% by mass or more.

When the molecular weight of the cellulose ester is large, elastic modulus increases but when the molecular weight is too large, productivity decreases since the viscosity of the dissolved solution of the cellulose ester is too high. The molecular weight of the cellulose ester is preferably from 70,000 to 200,000, more preferably from 100,000 to 200,000 as number average molecular weight (Mn). The Mw/Mn ratio of the cellulose ester for use in the invention is less than 33.0, preferably from 1.4 to 2.3.

Since the average molecular weight and the molecular weight distribution of the cellulose ester can be measured using a high performance liquid chromatography, the number average molecular weight (Mn) and weight average molecular weight (Mw) can be measured using the same to calculate the ratio.

The measuring conditions are as follows:

Solvent: methylene chloride

Column: Shodex K806, K805, K803G (three columns manufactured by Showa Denko K.K. are employed with connecting them)

Column temperature: 25° C.

Sample concentration: 0.1% by mass

Detector: RI Model 504 (manufactured by GL Science)

Pump: L6000 (manufactured by Hitachi, Ltd.)

Flow rate: 1.0 ml/min

Calibration curve: a calibration curve with 13 samples of standard polystyrenes STK standard polystyrenes (manufactured by Tosoh Corporation) having Mw of 1,000,000 to 500 are used. The 13 samples are preferably used at even intervals.

The cellulose ester film of the invention preferably contains a plasticizer, a UV absorber, an antioxidant, fine particles (mat agent), a retardation regulator, and the like.

The plasticizer is not particularly limited but a phosphate ester-based plasticizer, a phthalate ester-based plasticizer, a trimellitate ester-based plasticizer, a pyromellitate ester-based plasticizer, a glycolate-type plasticizer, a citrate ester-based plasticizer, a polyester-based plasticizer, or the like is preferably used.

There may be preferably used triphenyl phosphate, tricresyl phosphate, cresyl diphenyl phosphate, octyl diphenyl phosphate, diphenyl biphenyl phosphate, trioctyl phosphate, or tributyl phosphate as the phosphate ester-based plasticizer, diethyl phthalate, dimethoxyethyl phthalate, dimethyl phthalate, dioctyl phthalate, dibutyl phthalate, di-2-ethylhexyl phthalate, dicyclohexyl phthalate, or butyl benzyl phthalate as the phthalate ester-type plasticizer, tributyl trimellitate, triphenyl trimellitate, or triethyl trimellitate as the trimellitate-based plasticizer, tetrabutyl pyromellitate, tetraphenyl pyromellitate, or tetraethyl pyromellitate as the pyromellitate plasticizer, triacetin, tributyrin, ethylphthalylethyl glycolate, methylphthalylethyl glycolate, or butylphthalylbutyl glycolate as the glycolate-based plasticizer, triethyl citrate, tri-n-butyl citrate, triethyl acetylcitrate, tri-n-butyl acetylcitrate, or tri-n-(2-ethylhexyl)acetylcitrate as the citrate ester-based plasticizer.

Examples of the other carboxylate esters include butyl oleate, methyl acetyllicinolate, dibutyl sebacate, and dicyclohexyl phthalate.

As the polyester-based plasticizer, a copolymer of a dibasic acid such as an aliphatic dibasic acid, an alicyclic dibasic acid, or an aromatic dibasic acid with a glycol can be used. The aliphatic dibasic acid is not particularly limited and adipic acid, sebacic acid, phthalic acid, terephthalic acid, 1,4-cyclohexyldicarboxylic acid, or the like can be used. As the glycol, ethylene glycol, diethylene glycol, 1,3-propylene glycol, 1,2-propylene glycol, 1,4-butylene glycol, 1,3-butylene glycol, 1,2-butylene glycol, or the like can be employed. These dibasic acid and glycols may be used solely or as a mixture of two or more thereof, respectively.

The amount of these plasticizers to be used is preferably from 1 to 20% by mass based on the cellulose ester in view of film performance, processing ability, and the like.

As the UV absorber, one exhibiting an excellent absorbing ability of a ultraviolet ray having a wavelength of 370 nm or shorter and a small absorbance of a visible light having a wavelength of 400 nm or longer is preferably used from the viewpoint of good liquid-crystal displaying ability. As specific examples of the UV absorber to be preferably used, there may be mentioned oxybenzophenone-based compounds, benzotriazole-based compounds, triazine-based compounds, salicylate ester-based compounds, benzophenone-based compounds, cyanoacrylate-based compounds, nickel complex salt-based compounds, and the like but the UV absorber is not limited thereto. Moreover, polymer UV absorbers described in JP-A-6-148430 are also preferably employed.

As specific examples of the UV absorber to be useful in the invention, there may be mentioned 2-(2′-hydroxy-5′-methylphenyl)benzotriazole, 2-(2′-hydroxy-3′,5′-di-tert-butylphenyl)benzotriazole, 2-(2′-hydroxy-3′-tert-butyl-5′-methylphenyl)benzotriazole, 2-(2′-hydroxy-3′,5′-di-tert-butylphenyl)-5-chlorobenzotriazole, 2-(2′-hydroxy-3′-(3″,4″,5″6″-tetrahydrophthalimidomethyl)-5′-methylphenyl)benzotriazole, 2,2-methylenebis(4-(1,1,3,3-tetramethylbutyl)-6-(2H-benzotriazol-2-yl)phenol), 2-(2′-hydroxy-3′-tert-butyl-5′-methylphenyl)-5-chlorobenzotriazole, 2-(2H-benzotriazol-2-yl)-6-(linear and side chain dodecyl)-4-methylphenol <<TINUVIN 171>>, a mixture of 2-octyl-3-[3-tert-butyl-4-hydroxy-5-(chloro-2H-benzotriazol-2-yl)phenyl]propionate and 2-ethylhexyl-3-[3-tert-butyl-4-hydroxy-5-(5-chloro-2H-benzotriazol-2-yl)phenyl]propionate <<TINUVIN 109>>, 2-(2H-benzotriazol-2-yl)-4-methyl-6-tert-butylphenol <<TINUVIN 326>>, and the like but the UV absorber is not limited thereto. The above TINUVIN's such as TINUVIN 109, TINUVIN 171, and TINUVIN 326 are all commercial products manufactured by Ciba Specialty Chemicals and can be preferably used.

As specific examples of the benzophenone-based compound, there may be mentioned 2,4-dihydroxybenzophenone, 2,2′-dihydroxy-4-methoxybenzophenone, 2-hydroxy-4-methoxy-5-sulfobenzophenone, bis(2-methoxy-4-hydroxy-5-benzoylphenylmethane), and the like but it is not particularly limited thereto.

As specific examples of the triazine-based compound, the following compounds are preferred.

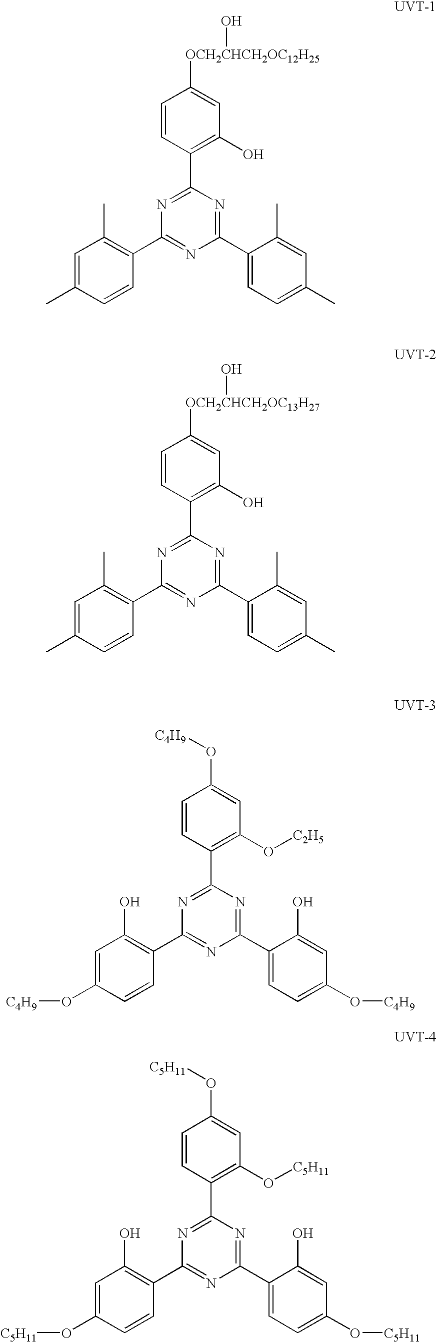

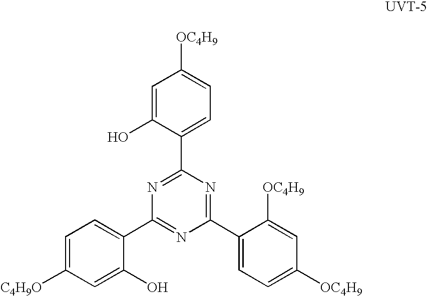

### [Mat Agent Particles]

The cellulose ester film in the invention preferably contains particles serving as a mat agent. The particles for use herein include silicon dioxide, titanium dioxide, aluminium oxide, zirconium oxide, calcium carbonate, talc, clay, calcined kaolin, calcined calcium silicate, calcium silicate hydrate, aluminium silicate, magnesium silicate and calcium phosphate. The particles are preferably silicon-having ones as the haze of the films containing them may be low. Especially preferred is silicon dioxide. Particles of silicon dioxide for use herein preferably have a primary mean particle size of at most 20 nm and have an apparent specific gravity of at least 70 g/liter. More preferred are particles having a small primary mean particle size of from 5 to 16 nm, since the haze of the films containing them is lower. The apparent specific gravity is more preferably from 90 to 200 g/liter, even more preferably from 100 to 200 g/liter. Particles having a larger apparent specific gravity may give a dispersion having a higher concentration, and are therefore preferable since the haze of the films containing them could be lower and since the solid deposits in the film may be reduced.

The particles generally form secondary particles having a mean particle size of from 0.1 to 3.0 μm, and in the film, they exist as aggregates of primary particles, therefore forming protrusions having a size of from 0.1 to 3.0 μm in the film surface. Preferably, the secondary mean particle size is from 0.2 μm to 1.5 μm, more preferably from 0.4 μm to 1.2 μm, most preferably from 0.6 m to 1.1 μm. The primary and secondary particle sizes are determined as follows: The particles in a film are observed with a scanning electromicroscope, and the diameter of the circle that is circumscribed around the particle is referred to as the particle size. 200 particles are observed at random in different sites, and their data are averaged to give the mean particle size thereof.

For silicon dioxide particles, herein usable are commercial products of Aerosil R972, R972V, R974, R812, 200, 200V, 300, R202, OX50, TT600 (all by Nippon Aerosil). Zirconium oxide particles are also commercially available, for example, as Aerosil R976 and R811 (both by Nippon Aerosil), and are usable herein.

Of those, Aerosil 200V and Aerosil R972V are silicon dioxide particles having a primary mean particle size of at most 20 nm and having an apparent specific gravity of at least 70 g/liter, and these are especially preferred for use herein since they are effective for reducing the friction coefficient of cellulose ester films not increasing the haze thereof.

In the invention, for obtaining a cellulose ester film that contains particles having a small secondary mean particle size, there may be employed some methods for preparing a dispersion of particles. For example, one method for it comprises previously preparing a dispersion of particles by stirring and mixing a solvent and particles, then adding the resulting dispersion to a small amount of a cellulose ester solution separately prepared, and thereafter further mixing it with a main dope. This method is desirable since the dispersibility of silicon dioxide particles is good and since the dispersion of silicon dioxide particles prepared hardly reaggregates. Apart from it, also employable herein is a method comprising adding a small amount of a cellulose ester to a solvent, dissolving them with stirring, and fully mixing the resulting dispersion of particles with a dope in an in-line mixer. The invention should not be limited to these methods. When silicon dioxide particles are mixed and dispersed in a solvent, the silicon dioxide concentration in the resulting dispersion is preferably from 5 to 30% by mass, more preferably from 10 to 25% by mass, most preferably from 15 to 20% by mass. Relative to the amount of the particles therein, the dispersion having a higher concentration may have a smaller haze, and is therefore favorable since the haze of the films with it may be lowered and the solid deposits may be reduced in the films. Finally, the amount of the mat agent to be in the dope is preferably from 0.01 to 1.0 g/m², more preferably from 0.03 to 0.3 g/m², most preferably from 0.08 to 0.16 g/m².

The cellulose ester film of the invention may contain a retardation regulator. The cellulose ester film of the invention can exhibit preferred retardation only after adding a compound increasing retardation (retardation-increasing agent) and stretching the film, and thereby the film can be used as a retardation film. As the retardation-increasing agent, a compound having a rod-shaped structure or a planer structure is preferably used. Moreover, a cellulose ester film having a small optical anisotropy can be obtained by incorporating a compound inhibiting orientation of the cellulose ester in the film in the in-plane and film-thickness directions (retardation-decreasing agent), and the film can be preferably used as a support of a protective film for a polarizing plate or an optically-compensatory film. For the purpose, it is advantageous that the compound decreasing optical anisotropy is sufficiently compatible to the cellulose ester and the compound itself does not have a rod-shaped structure or a planar structure. Specifically, in the case that it has a plurality of planar functional groups such as aromatic groups, a structure having the functional groups not in the same plane but in non-planar manner is advantageous.

In the invention, it is preferred to produce the cellulose ester film by a solution casting method and the film is produced using a dope. As an organic solvent to be preferably used as a main solvent in the invention, a solvent selected from esters, ketones, and ethers having 3 to 12 carbon atoms and halogenated hydrocarbons having 1 to 7 carbon atoms is preferred. The esters, ketones, and ethers may have a cyclic structure. A compound having two or more functional groups selected from ester, ketone, and ether groups, i.e., —O—, —CO— and —COO— can be also used as the main solvent and the compound may also have other functional group such as an alcoholic hydroxyl group.

The solvent to be used in the dope solution of the invention may contain a chlorine-based halogenated hydrocarbon as the main solvent and may contain a non-chlorine-based solvent as the main solvent as described in Hatsumei Kyokai's Disclosure Bulletin 2001-1745, pp. 12-16, and the solvent is not particularly limited.

In addition, solvents for the cellulose ester film of the invention are disclosed in the following patent publications including methods for dissolving the same, which are preferred embodiments. For example, they are described in JP-A 2000-95876, 12-95877, 10-324774, 8-152514, 10-330538, 9-95538, 9-95557, 10-235664, 12-63534, 11-21379, 10-182853, 10-278056, 10-279702, 10-323853, 10-237186, 11-60807, 11-152342, 11-292988, and 11-60752. In these patent publications, there are described not only solvents preferable for the dopes but also physical properties thereof and co-existing substances to be co-present, which are also preferred embodiments in the invention.

In the invention, the preparation of the dope is not particularly limited and may be carried out at room temperature or is carried out by a cool dissolving method or a high-temperature dissolving method or a combination thereof. With regard to the preparation of the dope and each step of solution concentration and filtration involved in the dissolution step in the invention, the production steps detailed in Hatsumei Kyokai's Disclosure Bulletin 2001-1745 (issued Mar. 15, 2001, by Hatsumei Kyokai), pp. 22-25 are preferably employed.

Next, a process of forming a film from the cellulose ester solution in the invention is described. For the method and the equipment for producing the cellulose ester film in the invention, herein employable are the solvent-casting method and the solvent-casting equipment heretofore generally used in the art for cellulose triacetate film formation. A dope prepared in a dissolver (tank) is once stored in a storage tank, in which the dope is defoamed and is thus finally prepared. From the dope take-out mouth of the tank, the dope is taken out and fed into a pressure die via a metering pressure gear pump capable of feeding it with accuracy, for example, based on the revolution number thereof, and then the dope is uniformly cast onto the endlessly-running cast member of a metal support via the slit of the pressure die, and at a peel point to which the metal support makes nearly one revolution, the still wet dope film (this may be referred to as a web) is peeled from the metal support. While both ends of the thus-obtained web are clipped to ensure its width, the web is conveyed with a tenter and dried, and then further conveyed with rolls in a drier in which the web is completely dried, and thereafter this is wound up around a winder to predetermined width. The combination of the tenter and the drier with rolls may vary depending on the object of the film to be produced. When the essential applications of the cellulose ester film of the invention are for functional protective films for optical structures in electronic displays or for silver halide photographic materials, then additional coating devices may be fitted to the solvent casting apparatus for producing the film. The additional devices are for further processing the surface of the film by forming thereon a subbing layer, an antistatic layer, an antihalation layer and a protective layer. This is described in detail in Hatsumei Kyokai's Disclosure Bulletin 2001-1745 (issued Mar. 15, 2001, by Hatsumei Kyokai), pp. 25-30. It includes casting (including co-casting), metal support, drying and peeling, and these are preferably employed in the invention. Moreover, the thickness of the cellulose ester film is preferably from 10 to 120 μm, more preferably from 20 to 100 μm, even more preferably 30 to 95 μm.

In the invention, the epoxy compound is polymerized (or crosslinked) simultaneously with drying by heating in the above drying step. The heating temperature and heating time vary depending on the epoxy compound or polymerization accelerator to be used. In general, the temperature is preferably 70° C. or higher, for example, from 70° C. to 170° C., more preferably from 80° C. to 160° C., most preferably 90° C. to 150° C. The drying (heating) time is preferably from 20 minutes to 240 minutes, most preferably from 30 minutes to 180 minutes.

The water vapor permeability of the cellulose ester film is desirably from 200 to 1800 g/m²·24 hr in terms of a film thickness of 80 μm in the measurement under conditions of a temperature of 60° C. and a humidity of 95% RH in accordance with JIS standard JIS Z0208. More preferred is from 300 to 1500 g/m²·24 hr and particularly preferred is from 400 to 1200 g/m²·24 hr. When it exceeds 1800 g/m²·24 hr, an absolute values of humidity dependence of an in-plane retardation Re and a retardation Rth in the thickness direction strongly tend to exceed 0.5 nm %/RH. Moreover, also in the case that an optically-compensatory film is formed by laminating an optically-anisotropic layer onto the cellulose ester film of the invention, the absolute values of humidity dependence of the Re and Rth strongly tend to exceeds 0.5 nm %/RH and hence the case is not preferred. In the case that the cellulose ester film or the optically-compensatory film is incorporated into a liquid-crystal display device, change in color and decrease in viewing angle are induced. Moreover, when the water vapor permeability of the cellulose ester film is less than 200 g/m²·24 hr, drying of an adhesive is inhibited by the cellulose ester film and an insufficient adhesion occurs in the case that the film is attached to both faces of a polarizer to prepare a polarizing plate.

The water vapor permeability decreases when the thickness of the cellulose ester film of the invention is large and the water vapor permeability increases when the film thickness is small. Therefore, it is necessary to convert the water vapor permeability with standardizing the film thickness to 80 μm in every sample having any film thickness. The conversion of the film thickness is determined as follows: water vapor permeability converted as 80 μm=water vapor permeability measured×film thickness measured μm/80 μm.

As the measuring method for the water vapor permeability, the methods described in “Kobunshi no Bussei II” ‘Kobunshi Jikken Koza 4, Kyoritsu Shuppan), pp. 285-294: Joki Tokaryo no Sokutei (Shisuryo-hou, Ondokei-hou, Jokiatsu-hou, Kyuchaku-hou) can be applied. A sample of the cellulose ester film of the invention (70 mmφ) is subjected to moisture conditioning at 25° C. and 90% RH or at 60° C. and 95% RH for 24 hours and the moisture content per unit area is calculated on a water vapor permeation testing equipment (KK-709007, Toyo Seiki K.K.) in accordance with JIS Z-0208 and the water vapor permeability is determined as follows: water vapor permeability=mass after moisture conditioning−mass before moisture conditioning.

The elastic modulus of the cellulose ester film of the invention is preferably from 200 to 500 kgf/mm² (1.96 to 4.9 GPa), more preferably from 240 to 470 kgf/mm² (2.35 to 4.61 GPa), even more preferably from 270 to 440 kgf/mm² (2.65 to 4.31 GPa). As a specific measuring method, stress at 0.5% elongation is measured at a tensile rate of 10%/minute under an atmosphere of 23° C. and 70% RH using a universal tensile tester S™ T50BP manufactured by Toyo Baldwin to determine the elastic modulus.

### <Use of Cellulose Ester Film>

### [Optically-Compensatory Film]

The cellulose ester film of the invention has many applications. When it is used for an optically-compensatory film in liquid-crystal display devices, it is especially effective. An optically-compensatory film is generally used in liquid-crystal display devices, and this is an optical member for compensating retardation. The optically-compensatory film has the same meaning as that of a phase retarder and an optically-compensatory sheet. The optically-compensatory film has a property of birefringence, and it is used for the purpose of removing coloration of display panels of liquid-crystal display devices and for improving the viewing angle characteristics of the devices.

In the cellulose ester film of the invention, in the case that retardation is expressed, the film itself can be preferably used as an optically-compensatory film. Moreover, in the other cases, the film can be preferably used as a support for an optically-anisotropic layer. With regard to the Re and Rth of the optically-anisotropic layer to be combined, preferably, Re₆₃₀ is from 0 to 200 nm and |Rth₆₃₀| is from 0 to 400 nm and an optically-anisotropic layer of any type may be used as far as it has such ranges of the values.

Specifically, the cellulose ester film of the invention may be combined with an optically-anisotropic layer of any type required in optically-compensatory films, not limited by the optical properties and the driving system of the liquid-crystal cell in the liquid-crystal display device in which the film is to be used. The optically-anisotropic layer to be combined with the film may be formed of a composition containing a liquid-crystal compound, or may be formed of a polymer film having a property of birefringence.

### [Optically-Anisotropic Layer Containing Liquid-Crystal Compound]

In the case that an optically-anisotropic layer containing a liquid-crystal compound is used as an optically-anisotropic layer, a discotic liquid-crystal compound or a rod-shaped liquid-crystal compound is preferred as the liquid-crystal compound.

### (Discotic Liquid-Crystal Compound)

Examples of the discotic liquid-crystal compound usable in the invention are described in various references (C. Destrade et al., Mol. Cryst. Liq. Cryst., Vol. 71, p. 111 (1981); Quarterly Journal of Outline of Chemistry, by the Chemical Society of Japan, No. 22, Chemistry of Liquid Crystal, Chap. 10, Sec. 2 (1994); B. Kohne et al., Angew. Chem. Soc. Chem. Comm., p. 1794 (1985); J. Zhang et al., J. Am. Chem. Soc., Vol. 116, p. 2655 (1994)).

Preferably, the discotic liquid-crystal molecules are fixed as aligned in the optically-anisotropic layer in the invention, most preferably fixed therein through polymerization. The polymerization of discotic liquid-crystal molecules is described in JP-A 8-27284. For fixing discotic liquid-crystal molecules through polymerization, a polymerizable group must be bonded to the disc core of each discotic liquid-crystal molecule as a substituent thereto. However, if such a polymerizable group is directly bonded to the disc core, then the molecules could hardly keep their orientation during polymerization. Accordingly, a linking group is introduced between the disc core and the polymerizable group to be bonded thereto. Such polymerizable group-having discotic liquid-crystal molecules are disclosed in JP-A 2001-4387.

### (Rod-Shaped Liquid-Crystal Compound)

Examples of the rod-shaped liquid-crystal compound usable in the invention are azomethines, azoxy compounds, cyanobiphenyls, cyanophenyl esters, benzoates, phenyl cyclohexanecarboxylates, cyanophenylcyclohexanes, cyano-substituted phenylpyrimidines, alkoxy-substituted phenylpyrimidines, phenyldioxanes, tolans, and alkenylcyclohexylbenzonitriles. Not only such low-molecular liquid-crystal compounds, but also high-molecular liquid-crystal compounds may also be usable herein.

In the optically-anisotropic layer, it is desirable that the rod-shaped liquid-crystal molecules are fixed in an aligned state, most preferably they are fixed through polymerization. Examples of the polymerizable rod-shaped liquid-crystal compound usable in the invention are described in Macromol. Chem., Vol. 190, p. 2255 (1989); Advanced Materials, Vol. 5, p. 107 (1993); U.S. Pat. Nos. 4,683,327, 5,622,648, 5,770,107; pamphlets of International Laid-Open Nos. 95/22586, 95/24455, 97/00600, 98/23580, 98/52905; JP-A 1-272551, 6-16616, 7-110469, 11-80081, 2001-328973.

### (Optically-Anisotropic Layer of Polymer Film)

As described in the above, the optically-anisotropic layer may be formed of a polymer film. The polymer film is formed from a polymer capable of expressing optical anisotropy. Examples of the polymer are polyolefin (e.g., polyethylene, polypropylene, norbornene-based polymer), polycarbonate, polyarylate, polysulfone, polyvinyl alcohol, polymethacrylate, polyacrylate and cellulose ester (e.g., cellulose triacetate, cellulose diacetate). Copolymers or mixtures of these polymers may also be usable herein.

The optical anisotropy of the polymer film is preferably generated by stretching. The stretching is preferably monoaxial stretching or biaxial stretching. Concretely, preferred is machine-direction monoaxial stretching to be attained by utilizing the peripheral speed difference between two or more rolls; or tenter stretching to be attained by clipping both sides of a polymer film and stretching it in the width direction; or biaxial stretching comprising a combination of these. If desired, two or more polymer films may be used so that the overall optical properties of these two or more films may satisfy the above-mentioned conditions. Preferably, the polymer film is produced according to a solvent casting method in order that the birefringence unevenness of the film is reduced as much as possible. Preferably, the thickness of the polymer film falls between 20 and 500 μm, most preferably between 40 and 100 μm.

Moreover, there may be also preferably employed a method of coating a substrate with a solution obtained by dissolving at least one polymer material selected from the group consisting of polyamides, polyimides, polyesters, polyether ketones, polyamide imides, polyester imides, and polyaryl ether ketones, as a polymer film composing an optically-anisotropic layer, in a solvent and drying the solvent to form a film. On this occasion, a method of stretching the polymer film and the substrate to express an optical anisotropy and using the film as an optically-anisotropic layer is also preferably employed. The cellulose ester film of the invention can be preferably used as a substrate in this case. Moreover, it is also preferred that the polymer film is separately prepared on another substrate and the polymer film after peeled from the substrate is attached onto the cellulose ester film of the invention to use the combined one as an optically-anisotropic layer. In this method, the thickness of the polymer film can be made small and is preferably from 50 μm or less, more preferably from 1 to 20 μm.

### [Polarizing Plate]

Next, the application of the cellulose ester film of the invention to a polarizing plate is explained.

The cellulose ester film of the invention is useful especially for a protective film for a polarizing plate. In the case of using it as a protective film for a polarizing plate, a method for manufacturing the polarizing plate is not particularly limited and can be manufactured by a common method. There is a method of subjecting the cellulose ester film obtained to alkaline treatment and attaching it onto both faces of a polarizer which has been prepared by immersing and stretching a polyvinyl alcohol film in an iodine solution and stretching the same using a completely saponified polyvinyl alcohol aqueous solution. Moreover, instead of the alkaline treatment, a processing for easy adhesion as described in JP-A 6-94915 and 6-118232 may be applied.

As the adhesive to be used for attaching the treated surface of the protective film to the polarizer, there may be, for example, mentioned polyvinyl alcohol-based adhesives such as polyvinyl alcohol and polyvinyl butyral and vinyl-based latexes such as butyl acrylate.

A polarizing plate is constituted by a polarizer and protective films protecting both faces thereof and further constituted by attaching a protect film on one face of the polarizing plate and a separate film on the other face. The protect film and the separate film are used for the purpose of protecting the polarizing plate at shipping of the polarizing plate and at product inspection. In this case, the protect film is attached for the purpose of protecting the surface of the polarizing plate and is used at the opposite face of the surface of the polarizing plate to be adhered to a liquid crystal cell. The separate film is used for the purpose of covering the adhesive layer to be attached to the liquid-crystal cell and is used at the face of the polarizing plate to be attached to the liquid-crystal cell.

In the liquid-crystal display device, a substrate containing a liquid crystal is usually arranged between two polarizing plates. The protective film for the polarizing plate to which the cellulose ester film of the invention is applied may be arranged at any site. To the protective film for the polarizing plate which is arranged at the top surface at the displaying side of the liquid-crystal display device, a clear hard coat layer, an antiglare layer, an antireflection layer, and the like are generally fitted. Even in that case, the protective film for the polarizing plate can be used at that part.

With regard to the polarizing plate obtained as above, in the case that two sheets thereof are attached to both faces of a glass substrate for use in a liquid crystal cell or the like so that the absorption axes of the sheets are positioned orthogonal each other, the difference between the transmittance of a light entering in the normal direction (in-plane transmittance) and the transmittance of a light entering at a tilt angle of 50° in the direction of 45° toward the absorption axis (transmittance in 50°-tilt direction) is preferably 1.0 or less. When the difference of the transmittance is 1.0 or less, a liquid-crystal display device having a good performance of the polarizing plate and a good property of viewing angle can be provided.

The difference of the transmittance can be determined by attaching two sheets of the polarizing plate to both faces of the glass substrate so that the absorption axes of the sheets are positioned orthogonal each other and then measuring a light entering at a tilt angle of polar angle 50°, when the absorption axis is regarded as an azimuthal angle of 0° and the normal line of the substrate is regarded as a polar angle of 0° in the direction of 45° thereof, and a light entering in the normal direction using a known measuring equipment such as a transmittance-measuring equipment “MCPD3000” (manufactured by Otsuka Denshi K.K.). In this connection, the reason why the direction of 45° is used toward the absorption axis is that the difference of the transmittance is larger in the case that a light enters at a tilt angle of 50° in the direction of 45° toward the absorption axis than the difference of the transmittance in the case that a light enters at a tilt angle of 50° in the same direction as that of the absorption axis. When the difference of the transmittance in the latter case is 1.0 or less, a good polarizing performance is obtained as described above.

### [Liquid-Crystal Display Device]

### [Constitution of Common Liquid-Crystal Display Device]

Next, a liquid-crystal display device using the cellulose ester film of the invention as a member is explained.

As described above, the cellulose ester film of the invention is suitably used as a protective film for the polarizing plate. In the case that the polarizing plate thus obtained is used in a liquid-crystal display device, the liquid-crystal display device has a constitution wherein a liquid-crystal cell supporting liquid crystals between two electrode substrates and two polarizing plates arranged at both faces thereof are arranged and suitably at least one optically-compensatory film is arranged between the liquid-crystal cell and the polarizing plate.

Moreover, in the case that the cellulose ester film of the invention is used as an optically-compensatory film, in the above constitution of the liquid crystal display device, the cellulose ester film may be used as at least one optically-compensatory film arranged between the liquid-crystal cell and the polarizing plate without changing the constitution or may be used as an integrated one after the side to which a liquid-crystal layer or a polymer layer as an optically-anisotropic layer is not fitted is directly attached to the polarizing plate to form an optically-compensatory and polarizing plate-protective film. On this occasion, the transmission axis of the polarizing film and the retardation axis of the optically-compensatory film can be arranged at any angle.

The liquid-crystal layer of the liquid-crystal cell is generally formed by introducing a liquid crystal into the space formed by two substrates via a spacer put therebetween, and sealed up in it. A transparent electrode layer is formed on a substrate as a transparent film that contains a conductive substance. The liquid-crystal cell may further have a gas barrier layer, a hard coat layer or an undercoat layer (for adhesion to transparent electrode layer). These layers are generally formed on a substrate. The substrate of the liquid-crystal cell generally has a thickness of from 50 μm to 2 mm.

### (Type of Liquid-Crystal Display Device)

The cellulose ester film of the invention may be used for liquid-crystal cells of various display modes. Various display modes such as TN (twisted nematic), IPS (in-plane switching), FLC (ferroelectric liquid-crystal), AFLC (anti-ferroelectric liquid-crystal), OCB (optically-compensatory bent), STN (super-twisted nematic), VA (vertically aligned), ECB (electrically-controlled birefringence) and HAN (hybrid aligned nematic) modes have been proposed. Also proposed are other display modes with any of the above-mentioned display modes aligned and divided. The cellulose ester film of the invention is effective in liquid-crystal display devices of any display mode. Further, it is also effective in any of transmission-type, reflection-type and semitransmission-type liquid-crystal display devices.

### (TN-Mode Liquid-Crystal Display Device)

The cellulose ester film of the invention may be used as a support of the optically-compensatory film or a protective film for the polarizing plate in TN-mode liquid-crystal cell-having TN-mode liquid-crystal display devices. TN-mode liquid-crystal cells and TN-mode liquid-crystal display devices are well known from the past. The optically-compensatory film to be used in TN-mode liquid-crystal display devices is described in JP-A 3-9325, 6-148429, 8-50206, 9-26572. In addition, it is also described in Mori et al's reports (Jpn. J. Appl. Phys., Vol. 36 (1997), p, 1068).

### (STN-Mode Liquid-Crystal Display Device)

The cellulose ester film of the invention may be used as a support of the optically-compensatory film or a protective film for the polarizing plate in STN-mode liquid-crystal cell-having STN-mode liquid-crystal display devices. In general, the rod-shaped liquid-crystal molecules in the liquid-crystal cell in an STN-mode liquid-crystal display device are twisted at an angle within a range of from 90 to 360 degrees, and the product of the refractivity anisotropy (Δn) of the rod-shaped liquid-crystal molecules and the cell gap (d), And falls between 300 and 1500 nm. The optically-compensatory film to be used in STN-mode liquid-crystal display devices is described in JP-A 2000-105316.

### (VA-Mode Liquid-Crystal Display Device)

The cellulose ester film of the invention is especially favorable for a support of the optically-compensatory film or a protective film for the polarizing plate in VA-mode liquid-crystal cell-having VA-mode liquid-crystal display devices. Preferably, the optically-compensatory film for use in VA-mode liquid-crystal display devices has a retardation Re of from 0 to 150 nm and a retardation Rth of from 70 to 400 nm. More preferably, the retardation Re of the sheet is from 20 to 70 nm. When two optically-anisotropic polymer films are used in a VA-mode liquid-crystal display device, then the retardation Rth of the films preferably falls between 70 and 250 nm. When one optically-anisotropic polymer film is used in a VA-mode liquid-crystal display device, then the retardation Rth of the film preferably falls between 150 and 400 nm. The VA-mode liquid-crystal display devices for the invention may have an orientation-divided system, for example, as in JP-A 10-123576.

### (IPS-Mode Liquid-Crystal Display Device and ECB-Mode Liquid-Crystal Display Device)

The cellulose ester film of the invention is also favorable for a support of the optically-compensatory film or a protective film for the polarizing plate in IPS-mode and ECB-mode liquid-crystal cell-having liquid-crystal display devices. These modes are embodiments wherein liquid crystal materials are aligned in almost parallel when black is displayed and black is displayed by aligning liquid-crystal molecules in parallel in a state where voltage is not applied. Preferably, an optically-anisotropic layer is arranged between the protective film for the polarizing plate and the liquid-crystal cell and the retardation of the arranged optically-anisotropic layer is set at a value twice or less the value of Δn·d of the liquid-crystal layer.

### (OCB-Mode Liquid-Crystal Display Device, and HAN-Mode Liquid-Crystal Display Device)

The cellulose ester film of the invention is also favorable for a support of the optically-compensatory film or a protective film for the polarizing plate in OCB-mode liquid-crystal cell-having OCB-mode liquid-crystal display devices and HAN-mode liquid-crystal cell-having HAN-mode liquid-crystal display devices. Preferably, the optically-compensatory film for use in OCB-mode liquid-crystal display devices and HAN-mode liquid-crystal display devices is so designed that the direction in which the absolute value of the retardation of the film is the smallest does not exist both in the in-plane direction and in the normal line direction of the optically-compensatory film. The optical properties of the optically-compensatory film for use in OCB-mode liquid-crystal display devices and HAN-mode liquid-crystal display devices are determined, depending on the optical properties of the optically-anisotropic layer, the optical properties of the support and the positional relationship between the optically-anisotropic layer and the support. The optically-compensatory film for use in OCB-mode liquid-crystal display devices and HAN-mode liquid-crystal display devices is described in JP-A 9-197397. It is described also in Mori et al's reports (Jpn. J. Appl. Phys., Vol. 38 (1999), p. 2837).

### (Reflection-Type Liquid-Crystal Display Device)

The cellulose ester film of the invention is also favorably used for an optically-compensatory film or a protective film for the polarizing plate in TN-mode, STN-mode, HAN-mode or GH (guest-host)-mode reflection-type liquid-crystal display devices. These display modes are well known from the past. TN-mode reflection-type liquid-crystal devices are described in JP-A 10-123478, pamphlet of International Laid-Open No. 98/48320, and Japanese Patent 3022477. The optically-compensatory film for use in reflection-type liquid-crystal display devices is described in pamphlet of International Laid-Open No. 00/65384.

### (Other Liquid-Crystal Display Devices)

The cellulose ester film of the invention is also favorably used as a support of the optical compensatory film or a protective film for the polarizing plate in ASM (axially symmetric aligned microcell)-mode liquid-crystal cell-having ASM-mode liquid-crystal display devices. The liquid-crystal cell in ASM-mode devices is characterized in that it is supported by a resin spacer capable of controlling and varying the thickness of the cell. The other properties of the cell are the same as those of the liquid-crystal cell in TN-mode devices. ASM-mode liquid-crystal cells and ASM-mode liquid-crystal display devices are described in Kume et al's report (Kume et al., SID 98 Digest 1089 (1998)).

### (Hard Coat Film, Antiglare Film, Antireflection Film)

The cellulose ester film of the invention is favorably applied to hard coat films, antiglare films and antireflection films. For the purpose of improving the visibility of flat panel displays such as LCD, PDP, CRT, EL, any or all of a hard coat layer, an antiglare layer and an antireflection layer may be fitted to one or both faces of the cellulose ester film of the invention. Preferred embodiments of such antiglare films and antireflection films are described in Hatsumei Kyokai's Disclosure Bulletin 2001-1745 (issued Mar. 15, 2001, by Hatsumei Kyokai), pp. 54-57, and the cellulose ester film of the invention may be favorably used in these. Moreover, these functional polarizing plate can be formed by fitting at least any of a hard coat layer, an antiglare layer, and an antireflection layer to the surface of the above polarizing plate and the resulting functional polarizing plate can be suitably used in liquid-crystal display devices.

### (Photographic Film Support)

The cellulose ester film usable in the invention is applicable to supports of silver halide photographic materials. Various materials and formulations and methods for processing them are described in some patent publications, and they may apply to the invention. Regarding the techniques, JP-A 2000-105445 has detailed descriptions of color negative films, and the cellulose ester film of the invention is favorably used in these. Also preferably, the film of the invention is applicable to supports of color reversal silver halide photographic materials, and various materials and formulations and methods for processing them described in JP-A 11-282119 are applicable to the invention.

### (Transparent Substrate)

Since the cellulose ester film of the invention has nearly zero optical anisotropy and has good transparency, it may be substitutable for the glass substrate for liquid-crystal cells in liquid-crystal display devices, or that is, it may be usable as a transparent support for sealing up the driving liquid crystals in the devices.

Since the transparent substrate for sealing up liquid crystal must have a good gas-barrier property, a gas-barrier layer may be optionally fitted to the surface of the cellulose ester film of the invention, if desired. The morphology and the material of the gas-barrier layer are not specifically defined. For example, SiO₂ may be deposited on at least one face of the cellulose ester film of the invention, or a polymer coating layer of a vinylidene-based polymer or a vinyl alcohol-based polymer having a relatively higher gas-barrier property may be formed on the film of the invention. These techniques may be suitably selected for use in the invention.

When the film of the invention is used as a transparent substrate for sealing up liquid crystal, a transparent electrode may be fitted to it for driving liquid crystal through voltage application thereto. The transparent electrode is not specifically defined. For example, a metal film or a metal oxide film may be laminated on at least one surface of the cellulose ester film of the invention so as to form a transparent electrode on it. Above all, a meal oxide film is preferred in view of the transparency, the electroconductivity and the mechanical characteristics of the film; and a thin film of indium oxide essentially comprising tin oxide and containing from 2 to 15% of zinc oxide is more preferred. These techniques are described in detail, for example, in JP-A 2001-125079 and 2000-22760.

### EXAMPLES

The following will further explain the invention with reference to Examples but the invention is not limited to the following examples.

### Example 1

### Preparation of Cellulose Acetate Solution

The following composition was charged into a mixing tank and stirred to dissolve individual components, whereby a cellulose acylate solution A was prepared.

<Composition of Cellulose Acetate Solution A>

| | | |
|---|---|---|
| Cellulose acetate having a degree of | 100.0 | parts by mass |
| acetyl substitution of 2.92 | | |
| Triphenyl phosphate | 8.0 | parts by mass |
| Biphenyl phosphate | 4.0 | parts by mass |
| TINUVIN 109 | 0.5 | part by mass |
| TINUVIN 171 | 0.5 | part by mass |
| UVT-5 | 0.5 | part by mass |
| Methylene chloride (first solvent) | 400.0 | parts by mass |
| Ethanol (second solvent) | 60.0 | parts by mass |

[Preparation of Mat Agent Solution]

The following composition was charged into a dispersing machine and stirred to dissolve individual components, whereby mat agent solution was prepared.

<Composition of Mat Agent Solution>

| | | |
|---|---|---|
| Silica particles having a mean particle | 2.0 | parts by mass |
| size of 16 nm (AEROSIL R972, manufactured | | |
| by Japan Aerosil K.K.) | | |
| Methylene chloride (first solvent) | 72.4 | parts by mass |
| Ethanol (second solvent) | 10.8 | parts by mass |
| Cellulose acetate solution A | 10.3 | parts by mass |

[Preparation of Epoxy Compound Solution]

The following composition was charged into a mixing tank and stirred under heating, whereby an epoxy compound solution was prepared.

<Composition of Epoxy Compound Solution>

| | |
|---|---|
| Epoxy compound I-3 | 20 parts by mass |
| Methylene chloride (first solvent) | 68 parts by mass |
| Ethanol (second solvent) | 12 parts by mass |

[Preparation of Polymerization Accelerator Solution]

The following composition was charged into a mixing tank and stirred under heating, whereby a polymerization accelerator solution was prepared.

<Composition of Polymerization Accelerator Solution>

| | |
|---|---|
| Polymerization accelerator H-4 | 20 parts by mass |
| Methylene chloride (first solvent) | 68 parts by mass |
| Ethanol (second solvent) | 12 parts by mass |

### (Manufacture of Cellulose Ester Film Sample A-1)

After filtration of each solution, 94.6 parts by mass of the above cellulose acetate solution A, 1.3 parts by mass of the mat agent solution, 4.2 parts by mass of the epoxy compound solution, and 2.1 parts by mass of the polymerization accelerator solution were mixed and the mixture was cast using a band casting machine. A film was peeled off at a residual solvent content of 35% and the film was stretched transversely at a stretching ratio of 25% under a condition of 130° C. using a tenter and kept at 140° C. for 30 seconds with maintaining the width after stretching. Thereafter, the clip was removed and the film was dried at 140° C. for 40 minutes (Drying 1) to produce a cellulose ester film sample A-1. The residual solvent content in the resulting cellulose ester film was 0.2% and the thickness was 92 μm.

Samples A-2 to A-17 were manufactured in the same manner except that the type and addition amount of the epoxy compound and polymerization accelerator were changed to the contents of Table 1, i.e., the type and concentration of the epoxy solution and polymerization accelerator solution were changed.

Furthermore, samples B-2 and B-11 corresponding to the samples A-2 and A-11 were manufactured similarly except that a polymer CAP (degree of substitution with acetyl group: 1.9, degree of substitution with propionyl group: 0.8) wherein part of cellulose acetate was changed to cellulose propionate is used instead of cellulose acetate.

Similarly, samples C-2 and C-11 corresponding to the samples A-2 and A-11 were manufactured similarly except that a polymer CAB (degree of substitution with acetyl group: 1.1, degree of substitution with butyryl group: 1.6) wherein part of cellulose acetate was changed to cellulose butyrate is used instead of cellulose acetate.

Next, samples D-2 and D-11 corresponding to the samples A-2 and A-11 were manufactured similarly except that triphenyl phosphate in the composition of the above cellulose acetate solution A was replaced by a retardation-decreasing agent X.

Moreover, samples E-2 and E-11 corresponding to the samples A-2 and A-11 were manufactured similarly except that triphenyl phosphate in the composition of the above cellulose acetate solution A was replaced by a retardation-increasing agent Y.

Retardation-decreasing agent X

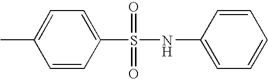

Retardation-increasing agent Y

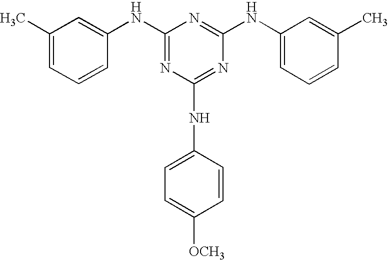

TABLE 1

| | | | Polymerization | | |
|---|---|---|---|---|---|
| | Epoxy compound | | accelerator | | |
| | | Amount | | Amount | |
| Sample | | (g/100 g | | (g/100 g | |
| No. | Type | of film) | Type | of film) | Remarks |
| A-1 | I-3 | 5 | H-4 | 2.0 | Invention |
| A-2 | I-3 | 10 | H-4 | 2.5 | Invention |
| A-3 | I-3 | 8 | H-4 | 3.0 | Invention |
| A-4 | I-4 | 10 | H-3 | 4.0 | Invention |
| A-5 | I-5 | 8 | H-5 | 3.5 | Invention |
| A-4 | I-8 | 8 | H-6 | 2.0 | Invention |
| A-5 | I-9 | 10 | H-10 | 3.0 | Invention |
| A-6 | II-1 | 10 | H-2 | 4.0 | Invention |
| A-7 | II-2 | 8 | H-11 | 2.0 | Invention |
| A-8 | III-1 | 10 | H-14 | 4.0 | Invention |
| A-9 | I-4 | 10 | H-16 | 4.0 | Invention |
| A-10 | I-4 | 10 | H-17 | 3.0 | Invention |
| | | | H-23 | 1.0 | |
| A-11 | None | None | None | None | Comparison |
| A-12 | I-3 | 8 | None | None | Comparison |
| A-13 | I-4 | 10 | None | None | Comparison |
| A-14 | I-5 | 8 | None | None | Comparison |
| A-15 | II-1 | 10 | None | None | Comparison |
| A-16 | II-2 | 8 | None | None | Comparison |
| A-17 | None | None | H-4 | 4.0 | Comparison |
| B-2 | I-3 | 5 | H-4 | 2.0 | Invention |
| B-11 | None | None | None | None | Comparison |
| C-2 | I-3 | 5 | H-4 | 2.0 | Invention |
| C-11 | None | None | None | None | Comparison |
| D-2 | I-3 | 5 | H-4 | 2.0 | Invention |
| D-11 | None | None | None | None | Comparison |
| E-2 | I-3 | 5 | H-4 | 2.0 | Invention |
| E-11 | None | None | None | None | Comparison |

The water vapor permeability of each sample was measured. As the measuring method for the water vapor permeability, the method described in “Kobunshi no Bussei II” ‘Kobunshi Jikken Koza 4, Kyoritsu Shuppan), pp. 285-294: Joki Tokaryo no Sokutei (Shisuryo-hou, Ondokei-hou, Jokiatsu-hou, Kyuchaku-hou) was applied. A sample of the cellulose ester film of the invention (70 mmφ) was subjected to moisture conditioning at 25° C. and 90% RH or at 60° C. and 95% RH for 24 hours and the moisture content per unit area (g/cm²) was calculated on a water vapor permeation testing equipment (KK-709007, Toyo Seiki K.K.) in accordance with JIS Z-0208 and the water vapor permeability was determined as follows: water vapor permeability=mass after moisture conditioning—mass before moisture conditioning. The results are shown in Table 2.

Also, the elastic modulus of each sample was measured.

As a specific measuring method, stress at 0.5% elongation was measured at a tensile rate of 10%/minute under an atmosphere of 23° C. and 70% RH using a universal tensile tester S™ T50BP manufactured by Toyo Baldwin to determine the elastic modulus. The results are shown in Table 2.

TABLE 2

| | Vapor | Elastic | |
|---|---|---|---|
| Sample | permeability | modulus | |
| No. | g/m² · 24 hr | Kgf/mm² | Remarks |
| A-1 | 1030 | 445 | Invention |
| A-2 | 970 | 478 | Invention |
| A-3 | 890 | 456 | Invention |
| A-4 | 810 | 490 | Invention |
| A-5 | 780 | 492 | Invention |
| A-4 | 825 | 498 | Invention |
| A-5 | 910 | 497 | Invention |
| A-6 | 850 | 456 | Invention |
| A-7 | 880 | 486 | Invention |
| A-8 | 990 | 442 | Invention |
| A-9 | 1050 | 440 | Invention |
| A-10 | 960 | 460 | Invention |
| A-11 | 1540 | 360 | Comparison |
| A-12 | 1460 | 370 | Comparison |
| A-13 | 1430 | 375 | Comparison |
| A-14 | 1370 | 375 | Comparison |
| A-15 | 1440 | 389 | Comparison |
| A-16 | 1470 | 385 | Comparison |
| A-17 | 1560 | 372 | Comparison |
| B-2 | 1100 | 440 | Invention |
| B-11 | 1790 | 310 | Comparison |
| C-2 | 1150 | 430 | Invention |
| C-11 | 1920 | 270 | Comparison |
| D-2 | 890 | 476 | Invention |
| D-11 | 1560 | 362 | Comparison |
| E-2 | 830 | 498 | Invention |
| E-11 | 1420 | 390 | Comparison |

From the results of Table 2, it is understood that the films according to the invention have a decreased water vapor permeability and an increased elastic modulus and are mechanically more tough.

### Example 2

The sample A-1 of the invention obtained in Example 1 was immersed in a 1.5N sodium hydroxide aqueous solution at 55° C. for 2 minutes. The sample was washed in a washing water bath at room temperature and then neutralized with 0.1N sulfuric acid at 30° C. The sample was again washed in a washing water bath at room temperature and further dried at 100° C.

Thus, the surface of the sample A-1 was saponified.

Subsequently, a roll-shaped polyvinyl alcohol film having a thickness of 80 μm was continuously stretched five times in an aqueous iodine solution and then dried to obtain a polarizer. Using a 3% aqueous solution of polyvinyl alcohol (PVA-117H manufactured by Kuraray Co., Ltd.) as an adhesive, two sheet of the sample A-1 subjected to alkali saponification were attached via the polarizer put therebetween to obtain a polarizing plate P-1, two faces of which were protected by the sample A-1.

Similarly, using the samples A-2 to A-17, B-2, B-11, C-2, C-11, D-2, D-11, E-2, and E-11, polarizing plates P-2 to P-25 were manufactured.

The polarizing plates P-1 to P-25 were allowed to stand under high-temperature and high-humidity conditions of 65° C. and 95% RH for 14 days and change in polarization degree before and after the treatment was determined.

The transmittance in the case that two sheets of the polarizing plate to be measured were overlaid each other so that the orientation directions of the polarizers thereof were identical with each other was referred to as parallel transmittance TP. The transmittance in the case that two sheets of the polarizing plate were overlaid each other so that the orientation directions of the polarizers thereof were orthogonal each other was referred to as orthogonal transmittance Tc. Then, a polarization degree P was calculated according to the following equation.

$$P = \sqrt{( Tp - Tc ) / ( Tp + Tc )} \times 100$$

Measures for the evaluation of durability are shown in Table 3 and results of the durability test in Table 4.

TABLE 3

| Durability rank | Change in degree of polarization |
|---|---|
| A | 0% or less, and larger than −0.1% |
| B | −0.1% or less, and larger than −0.3% |
| C | −0.3% or less, and larger than −1.0% |
| D | −1.0% or less, and larger than −2.0% |
| E | −2.0% or less |

TABLE 4

| | Constitution | | | | |
|---|---|---|---|---|---|
| | Protective | | Protective | | |
| | film (1) for | | film (2) for | | |
| Polarizing | polarizing | | polarizing | Dura- | |
| plate | plate | | plate | bility | Remarks |
| P-1 | A-1 | Polarizer | A-1 | B | Invention |
| P-2 | A-2 | Polarizer | A-2 | B | Invention |
| P-3 | A-3 | Polarizer | A-3 | A | Invention |
| P-4 | A-4 | Polarizer | A-4 | A | Invention |
| P-5 | A-5 | Polarizer | A-5 | A | Invention |
| P-6 | A-6 | Polarizer | A-6 | A | Invention |
| P-7 | A-7 | Polarizer | A-7 | B | Invention |
| P-8 | A-8 | Polarizer | A-8 | B | Invention |
| P-9 | A-9 | Polarizer | A-9 | B | Invention |
| P-10 | A-10 | Polarizer | A-10 | B | Invention |
| P-11 | A-11 | Polarizer | A-11 | E | Comparison |
| P-12 | A-12 | Polarizer | A-12 | E | Comparison |
| P-13 | A-13 | Polarizer | A-13 | E | Comparison |
| P-14 | A-14 | Polarizer | A-14 | D | Comparison |
| P-15 | A-15 | Polarizer | A-15 | E | Comparison |
| P-16 | A-16 | Polarizer | A-16 | E | Comparison |
| P-17 | A-17 | Polarizer | A-17 | E | Comparison |
| P-18 | B-2 | Polarizer | B-2 | B | Invention |
| P-19 | B-11 | Polarizer | B-11 | E | Comparison |
| P-20 | C-2 | Polarizer | C-2 | B | Invention |
| P-21 | C-11 | Polarizer | C-11 | E | Comparison |
| P-22 | D-2 | Polarizer | D-2 | A | Invention |
| P-23 | D-11 | Polarizer | D-11 | E | Comparison |
| P-24 | E-2 | Polarizer | E-2 | A | Invention |
| P-25 | E-11 | Polarizer | E-11 | D | Comparison |

It was confirmed that the polarizing plates P-1 to P-10, P-18, P-20, P-22, and P-24 using the samples A-1 to A-10, B-2, C-2, D-2, and E-2 as protective films for the polarizing plates, which were the cellulose ester films of the invention, exhibited a considerably low change in degree of polarization even when stored under high-temperature and high humidity conditions and thus were excellent in durability. To the contrary, it was confirmed that the cellulose films not containing at least one of the epoxy compound or the polymerization accelerator exhibited a large change in degree of polarization and thus were poor in durability.

### INDUSTRIAL APPLICABILITY

According to the invention, there is provided a cellulose ester film which is (1) less apt to cause deterioration of planarity, (2) less apt to absorb moisture, (3) low in water vapor permeability and excellent in storability, and (4) capable of reuse since formation of three-dimensionally crosslinked cellulose ester can be minimized. Moreover, since the cellulose ester film of the invention can be produced by casting a solution containing various components and heating it, it is not necessary to use a large-scale equipment which is necessary at photo-polymerization and hence the film is (5) excellent in productivity. Especially, in the case that the above oligomer is used as the epoxy compound, generation of pollution during production steps is suppressed since there is no problem of toxicity and volatility.

Moreover, according to the invention, there is provided a polarizing plate and a liquid-crystal display device constituted using the cellulose ester film.

The entire disclosure of each and every foreign patent application from which the benefit of foreign priority has been claimed in the present application is incorporated herein by reference, as if fully set forth.

1. A cellulose ester film comprising:
a cellulose ester; and
a reaction product between at least one epoxy compound and at least one polymerization accelerator.

2. The cellulose ester film according to claim 1,
wherein the cellulose ester is substantially not three-dimensionally crosslinked.

3. A cellulose ester film obtained by a method comprising:
casting a solution comprising a cellulose ester, at least one epoxy compound and at least one polymerization accelerator; and then
subjecting the casted solution to heat treatment at 70° C. or higher,
wherein the cellulose ester is substantially not three-dimensionally crosslinked.

4. The cellulose ester film according to claim 1,
wherein the at least one epoxy compound is at least one compound selected from the group consisting of compounds represented by formulae (I), (II), (III) and (IV): 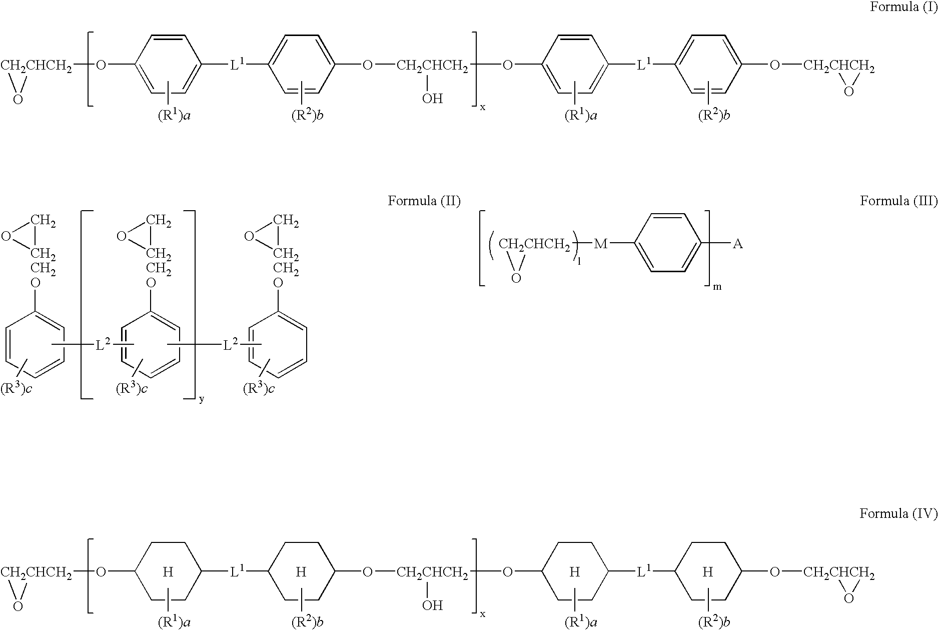
wherein R¹, R² and R³ each independently represents an alkyl group or a halogen atom;
L¹ and L² each independently represents a divalent aliphatic organic group;
M represents an oxygen atom or a nitrogen atom;
A represents a m-valent connecting group;
a, b and c each independently represents an integer of from 0 to 4;
x and y each independently represents a real number of from 0 to 20;
l represents 1 or 2; and
m represents an integer of from 2 to 4.

5. The cellulose ester film according to any of claim 1,
wherein the at least one polymerization accelerator is at least one compound selected from the group consisting of amine derivatives, acid anhydrides and imidazole derivatives.

6. The cellulose ester film according to claim 1,
wherein the cellulose ester has a degree of acyl substitution of from 2.9 to 3.0.

7. The cellulose ester film according to claim 1,
wherein the cellulose ester is a triacetyl cellulose, a cellulose acetate propionate or a cellulose acetate butyrate.

8. A polarizing plate comprising:
a polarizer; and
at least one protective layer of the polarizer,
wherein the at least one protective layer comprises a cellulose ester film according to any of claim 1.

9. A liquid-crystal display device comprising a cellulose ester film according to claim 1.

10. A liquid-crystal display device comprising a polarizing plate according to claim 8.

11. The cellulose ester film according to claim 3,
wherein the at least one epoxy compound is at least one compound selected from the group consisting of compounds represented by formulae (I), (II), (III) and (IV): 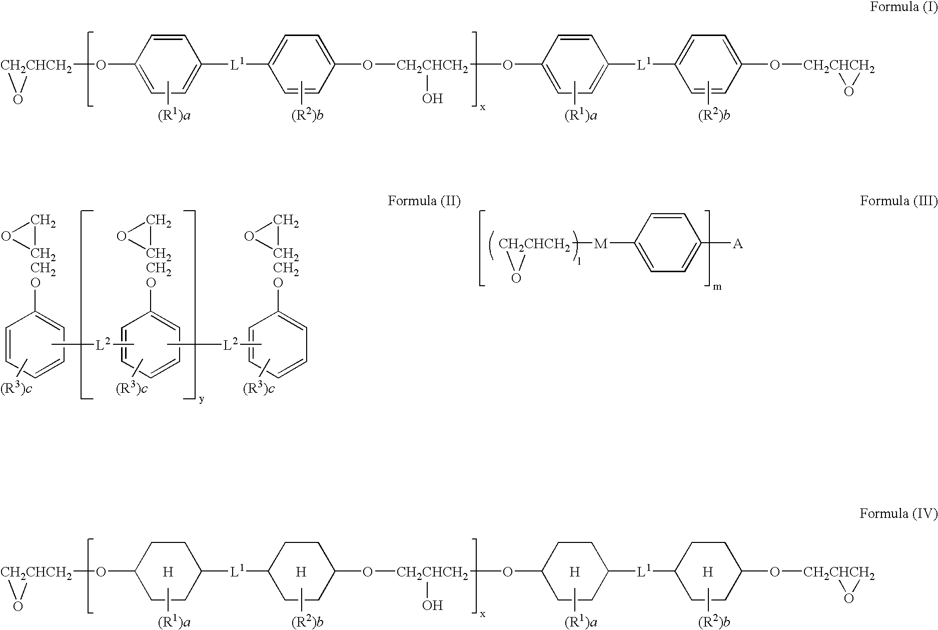
wherein R1, R2, and R3 each independently represents an alkyl group or a halogen atom;
L1 and L2 each independently represents a divalent aliphatic organic group;
M represents an oxygen atom or a nitrogen atom;
A represents a m-valent connecting group;
a, b and c each independently represents an integer of from 0 to 4;
x and y each independently represents a real number of from 0 to 20;
1 represents 1 or 2; and
m represents an integer of from 2 to 4.

12. The cellulose ester film according to claim 3,
wherein the at least one polymerization accelerator is at least one compound selected from the group consisting of amine derivatives, acid anhydrides and imidazole derivatives.

13. The cellulose ester film according to claim 3, wherein the cellulose ester has a degree of acyl substitution of from 2.9 to 3.0.

14. The cellulose ester film according to claim 3,
wherein the cellulose ester is a triacetyl cellulose, a cellulose acetate propionate or a cellulose acetate butyrate.

15. A polarizing plate comprising:
a polarizer; and
at least one protective layer of the polarizer,
wherein the at least one protective layer comprises
a cellulose ester film according to claim 3.

16. A liquid-crystal display device comprising a cellulose ester film according to claim 3.

17. A liquid-crystal display device comprising a polarizing plate according to claim 15.
